(19) United States
(12) Patent Application Publication
(10) Pub. No.: US 2014/0267965 A1
(43) Pub. Date: Sep. 18, 2014

(54) OPTICAL DEFLECTOR

(71) Applicant: Sharp Kabushiki Kaisha, Osaka-shi, Osaka (JP)

(72) Inventors: Yuuichi Kanbayashi, Osaka-shi (JP); Naru Usukura, Osaka-shi (JP)

(21) Appl. No.: 14/352,008

(22) PCT Filed: Nov. 12, 2012
(86) PCT No.: PCT/JP2012/007225

§ 371 Date: Apr. 15, 2014

(30) Foreign Application Priority Data
Nov. 18, 2011 (JP) 2011-252443

(51) Int. Cl. G02F 1/29

(52) U.S. Cl. CPC G02F 1/29
USPC 349/33

(57) ABSTRACT

An optical deflector includes: a first element substrate (20) including a first transparent electrode (12) located at a first transparent substrate (10a), an interlayer insulating layer (13) covering the first transparent electrode (12), and a plurality of second transparent electrodes (14) extending in parallel with one another on the interlayer insulating layer (13); a second element substrate (30) facing the first element substrate (20); a liquid crystal layer (40) provided between the first element substrate (20) and the second element substrate (30); and a drive circuit configured to apply signal voltages which are individually defined for the second transparent electrodes (14) and in which a low potential and a high potential are repeated as a whole, to the second transparent electrodes (14) and to apply a signal voltage at the low potential to the first transparent electrode (12).

### TECHNICAL FIELD

The present invention relates to optical deflectors, and particularly to an optical deflector using liquid crystal.

### BACKGROUND ART

An optical deflector using liquid crystal is configured to emit incident light with a change in deflection direction by forming a predetermined electric field distribution in a liquid crystal layer located between a pair of substrates.

Patent Document 1, for example, describes an optical deflector that electrically controls the orientation of a medium sandwiched between upper and lower transparent electrodes and having a refractive index anisotropy. Specifically, in the optical deflector of Patent Document 1, at least one of the transparent electrodes is constituted by at least a group of a plurality of individual electrodes with a striped pattern, and the individual electrodes in each group are connected by high-resistance wiring.

### CITATION LIST

### Patent Document

[Patent Document 1] Japanese Unexamined Patent Publication No. 2003-233094

### SUMMARY OF THE INVENTION

### Technical Problem

As described in Patent Document 1, an optical deflector using liquid crystal includes, for example, a first substrate on which a plurality of transparent electrodes are arranged in a striped pattern, a second substrate facing the first substrate and provided with a transparent common electrode, and a liquid crystal layer sandwiched between the first substrate and the second substrate. In the optical deflector using liquid crystal with the above-described configuration, a signal voltage at a low potential is applied to the common electrode and odd-numbered transparent electrodes, and a signal voltage at a high potential is applied to even-numbered transparent electrodes. Then, in the case of forming a blazed diffraction grating in the liquid crystal layer, portions of the liquid crystal layer near the odd-numbered transparent electrodes are readily affected by the voltage applied to their adjacent even-numbered transparent electrodes, and thus, a voltage applied to the portions of the liquid crystal layer near the odd-numbered transparent electrodes might be higher than a signal voltage at a low potential applied to these transparent electrodes. In this case, in the optical deflector, the phase difference caused by the diffraction grating in the liquid crystal layer decreases, thereby reducing the diffraction efficiency, which needs to be improved.

It is therefore an object of the present invention to increase the phase difference as much as possible.

### Solution to the Problem

To achieve the object, the present invention proposes that a first transparent electrode is disposed at the sides of parallel second transparent electrodes facing the first transparent substrate in a first element substrate.

Specifically, an optical deflector according to the present invention includes: a first element substrate including a first transparent substrate, a first transparent electrode located at the first transparent substrate, an interlayer insulating layer covering the first transparent electrode, and a plurality of second transparent electrodes extending in parallel with one another on the interlayer insulating layer; a second element substrate including a second transparent substrate and a third transparent electrode located at the second transparent substrate, the third transparent electrode facing the second transparent electrodes on the first element substrate; a liquid crystal layer disposed between the first element substrate and the second element substrate; and a drive circuit configured to apply signal voltages which are individually defined for the second transparent electrodes and in which a low potential and a high potential are repeated as a whole, to the second transparent electrodes, and to apply a signal voltage at the low potential to the first transparent electrode.

In this configuration, in the first element substrate, the second transparent electrodes extend in parallel to one another on the interlayer insulating layer, and the drive circuit applies, to the second transparent electrodes, signal voltages which are individually defined for the second transparent electrodes and in which a low potential and a high potential are repeated as a whole. Thus, a difference in refractive index occurs between portions corresponding to the second transparent electrodes to which a signal voltage at the low potential is applied and a portion corresponding to the second transparent electrodes to which a signal voltage at the high potential is applied. Then, a continuous refractive index difference occurs in the liquid crystal layer. Consequently, a dip of a blazed diffraction grating is formed in portions corresponding to the second transparent electrodes to which a signal voltage at the low potential is applied, and a peak of the blazed diffraction grating is formed in portions corresponding to the second transparent electrodes to which a signal voltage at the high potential is applied. Here, in a transmissive (blazed) diffraction grating, a phase difference is obtained by dividing the difference between the optical distance of passage of light in the dip of the diffraction grating and the optical distance of passage of light in the peak of the diffraction grating by the wavelength of light. Thus, in an optical deflector using liquid crystal, the phase difference is increased by increasing the difference in refractive index between portions to which a signal voltage at a low potential is applied and portions to which a signal voltage at a high potential is applied. In the first element substrate, the first transparent electrode is provided at the sides of the second transparent electrodes facing the first transparent substrate, and the drive circuit applies a signal voltage at the low potential to the first transparent electrode (and the third transparent electrode of the second element substrate). Thus, portions of the liquid crystal layer near the second transparent electrodes to which the signal voltage at the low potential is applied have a lower potential than that in a case where the first transparent electrode is not provided. In this manner, the difference between the refractive index of portions of the liquid crystal layer near the second transparent electrodes to which a signal voltage at the low potential is applied and the refractive index of portions of the liquid crystal layer near the second transparent electrodes to which a signal voltage at the high potential is applied becomes larger than that in a case where the first transparent electrode is not provided. Thus, the phase difference can be increased as much as possible.

The drive circuit may apply, to the second transparent electrodes to which a signal voltage at the high potential is applied, a signal voltage higher than an applied voltage whose phase in the second transparent electrodes changes by 2π.

In this configuration, the first transparent electrode is disposed at the sides of the second transparent electrodes facing the first transparent substrate. Thus, even when the electric field distribution shifts to lower potentials, the phase difference can be maintained or increased because the drive circuit applies, to the second transparent electrodes to which a signal voltage at a high potential is applied, signal voltages higher than an applied voltage whose phase in the second transparent electrodes changes by 2π.

The drive circuit may apply, to the second transparent electrodes, signal voltages in which a first potential and a second potential higher than the first potential are repeated, using adjacent 2n (where n is a natural number) of the second transparent electrodes as one unit.

In this configuration, the drive circuit applies signal voltages in which a low first potential and a high second potential are repeated, to the second transparent electrodes, using each adjacent two of the second transparent electrodes as one unit. Thus, signal voltages with a spatially rectangular pattern are applied to the second transparent electrodes along the direction of arrangement of the electrodes.

The drive circuit may apply, to the second transparent electrodes, signal voltages in which a first potential, a second potential, . . . , and an n-th potential that increase in this order are repeated, using adjacent n (where n is a natural number greater than or equal to three) of the second transparent electrodes as one unit.

In this configuration, the drive circuit applies, to the second transparent electrodes, signal voltages in which a first potential, a second potential, . . . and an n-th potential are repeated, using adjacent n (where n is a natural number greater than or equal to three) of the second transparent electrodes as one unit. Thus, signal voltages with a spatially stepped pattern are applied to the second transparent electrodes along the direction of arrangement of the electrodes.

The drive circuit may apply, to the second transparent electrodes, signal voltages in which a first potential, a second potential, . . . , an (n+1)th potential, and an (n+2)th potential that increase in this order and an (n+3)th potential equal to the (n+1)th potential, . . . and an (2n+2)th potential equal to the second potential that decrease in this order are repeated, using adjacent 2n+2 (where n is a natural number) of the second transparent electrodes as one unit.

In this configuration, the drive circuit applies, to the second transparent electrodes, signal voltages in which a first potential, a second potential, . . . , an (n+1)th potential, and an (n+2)th potential that increase in this order and an (n+3)th potential, . . . and a (2n+2)th potential that decrease in this order are repeated, using adjacent 2n+2 (where n is a natural number) of the second transparent electrodes as one unit. Thus, signal voltages with a spatially sinusoidal pattern are applied to the second transparent electrodes along the direction of arrangement of the electrodes.

The drive circuit may make a potential of a signal voltage to be applied to the third transparent electrode equal to a potential of a signal voltage at the low potential to be applied at least one of the second transparent electrodes.

In this configuration, the drive circuit makes a signal voltage to be applied to the third transparent electrode equal to a signal voltage at the low potential to be applied to at least one of the second transparent electrodes. Thus, a blazed diffraction grating is specifically formed in the liquid crystal layer.

The drive circuit may make a potential of a signal voltage to be applied to the third transparent electrode equal to a potential of a signal voltage at the first potential to be applied to at least one of the second transparent electrodes.

In this configuration, the drive circuit makes a signal voltage to be applied to the third transparent electrode equal to a signal voltage at the first potential to be applied to at least one of the second transparent electrodes. Thus, a blazed diffraction grating is specifically formed in the liquid crystal layer.

### Advantages of the Invention

According to the present invention, in the first element substrate, the first transparent electrode is provided at the sides of the second transparent electrodes facing the first transparent substrate. Thus, the phase difference can be as much as possible increased.

### BRIEF DESCRIPTION OF THE DRAWINGS

FIG. 1 is a cross-sectional view of an optical deflector according to a first embodiment.

FIG. 2 is a plan view of a first element substrate constituting the optical deflector of the first embodiment.

FIG. 3 schematically illustrates the optical deflector of the first embodiment.

FIG. 4 is a graph showing a pattern of application of a signal voltage in the optical deflector of the first embodiment.

FIG. 5 shows an electric field distribution in a liquid crystal layer constituting the optical deflector of the first embodiment.

FIG. 6 shows a liquid crystal director in the liquid crystal layer constituting the optical deflector of the first embodiment.

FIG. 7 is a graph showing a phase profile in the optical deflector of the first embodiment.

FIG. 8 illustrates a relationship between an electrode configuration and a phase profile in the optical deflector of the first embodiment.

FIG. 9 is a graph showing a relationship between an applied voltage in a high-potential applied portion and a phase in the optical deflector of the first embodiment.

FIG. 10 is a graph showing a relationship between an applied voltage and a phase difference in the optical deflector of the first embodiment.

FIG. 11 is a graph showing an application pattern of a variation of signal voltages in the optical deflector of the first embodiment.

FIG. 12 shows an application pattern of signal voltages in an optical deflector according to a second embodiment.

FIG. 13 is a graph showing a phase profile in the optical deflector of second embodiment.

FIG. 14 shows an application pattern of a first variation of signal voltages in the optical deflector of the second embodiment.

FIG. 15 shows an application pattern of a second variation of signal voltages in the optical deflector of the second embodiment.

FIG. 16 schematically illustrates a simplified configuration of an optical deflector according to a third embodiment.

FIG. 17 shows an application pattern of signal voltages in the optical deflector of the third embodiment.

FIG. 18 is a graph showing a phase profile in the optical deflector of the third embodiment.

FIG. 19 shows an application pattern of a first variation of signal voltages in the optical deflector of the third embodiment.

FIG. 20 shows an application pattern of a second variation of signal voltages in the optical deflector of the third embodiment.

FIG. 21 is a cross-sectional view illustrating an optical deflector of a comparative example.

FIG. 22 shows an electric field distribution in a liquid crystal layer constituting the optical deflector of the comparative example.

FIG. 23 shows a liquid crystal director in the liquid crystal layer constituting the optical deflector of the comparative example.

### DESCRIPTION OF EMBODIMENTS

Embodiments of the present invention will be described with reference to the drawings. The present invention is not limited to the embodiments below.

### First Embodiment

FIGS. 1-11 illustrate an optical deflector according to a first embodiment of the present invention. Specifically, FIG. 1 is a cross-sectional view of an optical deflector 50 of this embodiment. FIG. 2 is a plan view of a first element substrate 20 constituting the optical deflector 50.

As illustrated in FIG. 1, the optical deflector 50 includes: a first element substrate 20 and a second element substrate 30 that face each other; a liquid crystal layer 40 of a homogeneous alignment type sandwiched between the first element substrate 20 and the second element substrate 30; and a sealing material (not shown) bonding the first element substrate 20 and the second element substrate 30 together and having a frame shape for enclosing the liquid crystal layer 40 between the first element substrate 20 and the second element substrate 30. A blazed diffraction grating G is formed in the liquid crystal layer 40. In the optical deflector 50, an effective region E (see FIG. 2) serving as the diffraction grating G is defined.

As illustrated in FIGS. 1 and 2, the first element substrate 20 includes: a first transparent substrate 10a; a plurality of signal lines 11 extending in parallel to one another (in the vertical direction in FIG. 2) on the first transparent substrate 10a; a first interlayer insulating layer (not shown) covering the signal lines 11; a first transparent electrode 12 provided on the first transparent substrate 10a; a second interlayer insulating layer 13 covering the first transparent electrode 12; a plurality of parallel second transparent electrodes 14 extending in parallel to one another (in the lateral direction in FIG. 2) on the second interlayer insulating layer 13; and an alignment film 15 covering the second transparent electrodes 14. On the first element substrate 20, a drive circuit 45 is mounted outside the effective region E. In this embodiment, the solid first transparent electrode 12 is illustrated as an example. Alternatively, the first transparent electrode 12 may have a striped pattern intersecting with the second transparent electrodes 14.

As illustrated in FIG. 2, on the first element substrate 20, the second transparent electrodes 14 are individually connected to the signal lines 11 through contact holes (not shown) formed in the first interlayer insulating layer. The signal lines 11 are connected to the drive circuit 45, and the first transparent electrode 12 is connected to the drive circuit 45 through another signal line.

The drive circuit 45 is configured to apply, to the second transparent electrodes 14 (14a-14f, see FIG. 3), signal voltages which are individually defined for the transparent electrodes 14a-14f and in which a low potential and a high potential are repeated as a whole. Specifically, using adjacent two of the second transparent electrodes 14 (14a-14f) as one unit, signal voltages in which a low first potential (0 V) and a high second potential (6 V) are repeated are applied to the second transparent electrodes 14 (14a-14f), and a signal voltage at the low first potential (0 V) is applied to the first transparent electrode 12 and a third transparent electrode 22, which will be described later, as shown in FIG. 4. For the reasons described below, the drive circuit 45 is configured to apply a higher signal voltage to the second transparent electrodes 14b, 14d, and 14f to which the signal voltage at the second potential is applied, than an applied voltage whose phase in the second transparent electrodes 14b, 14d, and 14f changes by 2π.

As illustrated in FIG. 1, the second element substrate 30 includes: a second transparent substrate 10b; a third interlayer insulating layer 21 located on the second transparent substrate 10b; a third transparent electrode 22 located on the third interlayer insulating layer 21; and an alignment film 23 covering the second transparent electrode 22.

As illustrated in FIG. 1, in the optical deflector 50, the third transparent electrode 22 of the second element substrate 30 faces the second transparent electrodes 14 of the first element substrate 20.

The liquid crystal layer 40 is made of, for example, a nematic liquid crystal material having electrooptic characteristics, whose dielectric constant anisotropy is positive. As a liquid crystal mode, an electrically controlled birefringence (ECB), optically compensated bend (OCB), or in-plane-switching (IPS) may be employed, for example.

Then, a method for fabricating an optical deflector 50 according to this embodiment will be described. The method for fabricating an optical deflector 50 of this embodiment includes a first element substrate fabrication step, a second element substrate fabrication step, and a liquid crystal injection step.

First Element Substrate Fabrication Step

First, a metal film such as a titanium film is deposited by, for example, sputtering over an entire first transparent substrate 10a such as a glass substrate to a thickness of about 50-500 nm. Then, the metal film is subjected to photolithography, dry etching, and resist removal and cleaning, thereby forming signal lines 11.

Next, an inorganic insulating film such as a silicon oxide film is deposited by plasma chemical vapor deposition (CVD) over the entire substrate including the signal lines 11 to a thickness of about 100-1000 nm. Then, the inorganic insulating film is subjected to photolithography, dry etching, and resist removal and cleaning, thereby forming a first interlayer insulating layer. To bring the signal lines 11 into direct contact with the second transparent electrodes 14, the first interlayer insulating layer may not be provided.

Then, a transparent conductive film such as an indium zinc oxide (IZO) film is deposited by, for example, sputtering over the entire substrate including the first interlayer insulating layer to a thickness of about 100-150 nm. Then, the transparent conductive film is subjected to photolithography, wet etching, and resist removal and cleaning, thereby forming a first transparent electrode 12.

Thereafter, an inorganic insulating film such as a silicon oxide film is deposited by, for example, plasma CVD over the entire substrate including the first transparent electrode 12 to a thickness of about 100-1000 nm. Then, the inorganic insulating film is subjected to photolithography, dry etching, and resist removal and cleaning, thereby forming a second interlayer insulating layer 13.

Subsequently, a transparent conductive film such as an IZO film is deposited by, for example, sputtering over the entire substrate including the second interlayer insulating layer 13 to a thickness of about 100-150 nm. Then, the transparent conductive film is subjected to photolithography, wet etching, and resist removal and cleaning, thereby forming second transparent electrodes 14.

Lastly, the entire substrate including the second transparent electrodes 14 is coated with a resin film of polyimide by, for example, printing. This coating film is then subjected to baking and rubbing, thereby forming an alignment film 15.

In the foregoing manner, a first element substrate 20 can be fabricated.

Second Element Substrate Fabrication Step

First, an inorganic insulating film such as a silicon oxide film is deposited by, for example, plasma CVD over an entire second transparent substrate 10b such as a glass substrate to a thickness of about 100-1000 nm, thereby forming a third interlayer insulating layer 21.

Next, a transparent conductive film such as an IZO film is deposited by, for example, sputtering over the entire substrate including the third interlayer insulating layer 21 to a thickness of about 100-150 nm, thereby forming a third transparent electrode 22.

Then, the entire substrate including the third transparent electrode 22 is coated with a resin film of polyimide by, for example, printing. This coating film is then subjected to baking and rubbing, thereby forming an alignment film 23.

In the foregoing manner, a second element substrate 30 can be fabricated.

Liquid Crystal Injection Step

First, for example, a sealing material of, for example, an ultraviolet (UV)/thermosetting resin is printed in a frame shape on the surface of the second element substrate 30 obtained by the above-described second element substrate fabrication step, and then a liquid crystal material is dropped inside the frame of the sealing material.

Thereafter, the second element substrate 30 on which the liquid crystal material has been dropped and the first element substrate 20 fabricated by the above-described first element substrate fabrication step are bonded together under a reduced pressure to form a bonded assembly. This bonded assembly is then exposed to the air under an atmospheric pressure, thereby pressurizing the front and back surfaces of the bonded assembly.

Subsequently, the sealing material enclosed in the bonded assembly is irradiated with UV light, and then the bonded assembly is heated, thereby curing the sealing material.

In the foregoing manner, an optical deflector 50 of this embodiment can be fabricated. Although this embodiment employs a fabrication method using a one drop fill (ODF) process, the optical deflector 50 may be fabricated by a vacuum injection process.

Then, it will be described how the optical deflector 50 of this embodiment operates with reference to FIGS. 3-11. FIG. 3 schematically illustrates a simplified configuration of the optical deflector 50, where only the first transparent electrode 12, the second transparent electrodes 14 (14a-14f), and the third transparent electrode 22 are shown. FIG. 4 shows a pattern of application of signal voltages in the optical deflector 50. FIGS. 5 and 6 respectively show an electric field distribution and a liquid crystal director in the liquid crystal layer 40 constituting the optical deflector 50 with the application pattern of signal voltages in FIG. 4. FIG. 7 shows a phase profile in the optical deflector 50 with the application pattern of signal voltages in FIG. 4. In the graph of FIG. 7, solid curve A represents the optical deflector 50 of this embodiment, and broken curve B represents an optical deflector 150 of a comparative example, which will be described later.

As illustrated in FIGS. 3 and 4, in the optical deflector 50, a signal voltage of 0 V is applied to the first transparent electrode 12, the second transparent electrode 14a, the second transparent electrode 14c, the second transparent electrode 14e, and the third transparent electrode 22, and a signal voltage of 6 V is applied to the second transparent electrode 14b, the second transparent electrode 14d, and the second transparent electrode 14f. Then, as illustrated in the voltage distribution of FIG. 5, voltages near the second transparent electrode 14a, the second transparent electrode 14c, and the second transparent electrode 14e are about 0.3-1.7 V, i.e., approaches 0 V, and thus, the phase difference relatively increases (see curve A in FIG. 7). In this case, the director of the liquid crystal layer 40 facing the second transparent electrode 10b is parallel to the substrate surface, as illustrated in FIG. 6.

On the other hand, in the optical deflector 150 of the comparative example illustrated in FIG. 21, a signal voltage of 0 V is applied to a second transparent electrode 114a, a second transparent electrode 114c, a second transparent electrode 114e, and a third transparent electrode 122, and a signal voltage of 6 V is applied to a second transparent electrode 114b, a second transparent electrode 114d, and a second transparent electrode 114f. Then, as illustrated in the voltage distribution of FIG. 22, voltages near the second transparent electrode 114a, the second transparent electrode 114c, and the second transparent electrode 114e are about 0.5-2.0 V, and thus, the phase difference relatively decreases (see curve B in FIG. 7). Here, the director in a liquid crystal layer 140 facing a second transparent electrode 110b is slightly tilted relative to the substrate surface, as illustrated in FIG. 23. FIG. 21 is a cross-sectional view of the optical deflector 150 of the comparative example. FIGS. 22 and 23 respectively illustrate an electric field distribution and a liquid crystal director in the liquid crystal layer 140 constituting the optical deflector 150 with the application pattern of signal voltages in FIG. 4. As illustrated in FIG. 21, the optical deflector 150 includes: a first element substrate 120 and a second element substrate 130 that face each other; and a liquid crystal layer 140 of a homogeneous alignment type sandwiched between the first element substrate 120 and the second element substrate 130. As illustrated in FIG. 21, the first element substrate 120 includes: a first transparent substrate 110a; a plurality of second transparent electrodes 114 (114a-114f) provided on the first transparent substrate 110a with a first interlayer insulating layer 113 interposed therebetween and extending in parallel with one another; and an alignment film 115 covering the second transparent electrodes 114. As illustrated in FIG. 21, the second element substrate 130 includes: a second transparent substrate 110b; a second transparent electrode 122 provided on the second transparent substrate 110b with the second interlayer insulating layer 121 interposed therebetween; and an alignment film 123 covering the second transparent electrode 122.

Now, the level of signal voltages at a high potential applied to the second transparent electrodes 14b, 14d, and 14f will be described. FIG. 8 illustrates a relationship between an electrode configuration and a phase profile in the optical deflector 50. FIG. 9 is a graph showing a relationship between an applied voltage in a high-potential applied portion and a phase in the optical deflector 50. FIG. 10 is a graph showing a phase difference (indicated by Pd in FIG. 8) when the applied voltage in the high-potential applied portion of the optical deflector 50 varies. In the graphs of FIGS. 9 and 10, solid curve A represents the optical deflector 50 of this embodiment having a two-layer electrode configuration, and broken curve B represents the optical deflector 150 of the comparative example having a single-layer electrode configuration.

In the optical deflector 50 having the two-layer electrode configuration (i.e., the second transparent electrode/the first transparent electrode), a signal voltage at a low potential applied to the first transparent electrode 12 shifts the entire electric field distribution of the liquid crystal layer 40 toward lower potentials, as illustrated in FIG. 5. Thus, as illustrated in FIG. 9, a phase change (see curve A in the graph) in portions corresponding to the second transparent electrodes 14b, 14d, and 14f to which signal voltages at a high potential are applied (see region R in FIG. 8) becomes smaller than that of the optical deflector 150 of the comparative example (see curve B in the graph) having the single-layer electrode configuration (i.e., the second transparent electrode). For this reason, in the optical deflector 50 having the two-layer electrode configuration (i.e., the second transparent electrode/the first transparent electrode), higher signal voltages need to be applied to the second transparent electrodes 14b, 14d, and 14f in order to obtain a phase change substantially equal to that of the optical deflector 150 having the single-layer electrode configuration (i.e., the second transparent electrode). As illustrated in FIG. 10, the phase difference (see curve A in the graph) in the optical deflector 50 having the two-layer electrode configuration becomes larger than the phase difference (see curve B in the graph) in the optical deflector 150 having the single-layer electrode configuration when the applied voltage is 5 V or more. Thus, in the optical deflector 50, signal voltages at a high potential greater than or equal to 5 V need to be applied to the second transparent electrodes 14b, 14d, and 14f. At this time, as illustrated in FIG. 9, the phases in portions corresponding to the second transparent electrodes 14b, 14d, and 14f to which signal voltages at a high potential are applied are larger than 2π(6.28). Thus, the drive circuit 45 applies, to the second transparent electrodes 14b, 14d, and 14f to which signal voltages at a high potential are applied, signal voltages higher than an applied voltage whose phase in these portions changes by 2π. In this embodiment, as illustrated in FIG. 10, when the applied voltage is about 6 V, the phase difference is at the maximum. Thus, the case of applying a signal voltage of 6 V to the second transparent electrodes 14b, 14d, and 14f to which signal voltages at a high potential are applied is shown.

Here, in the optical deflector 50 of this embodiment, using adjacent two of the second transparent electrodes 14 as one unit, signal voltages in which the first potential (0 V) and the second potential (6 V) are repeated are applied to the second transparent electrodes 14, for example. Alternatively, in the optical deflector 50, using adjacent 2n (where n is a natural number) of the second transparent electrodes 14 as one unit, for example, using adjacent four of the second transparent electrodes 14 as one unit as illustrated in FIG. 11, signal voltages in which the first potential (0 V) and the second potential (6 V) are repeated may be applied such that a signal voltage at the first potential (0 V) is applied to the second transparent electrodes 14a and 14b and a signal voltage at the second potential (6 V) is applied to the second transparent electrodes 14c and 14d. FIG. 11 is a graph showing an application pattern of a variation of signal voltages in the optical deflector 50.

As described above, in the first element substrate 20 of the optical deflector 50 of this embodiment, the second transparent electrodes 14 extend in parallel to one another on the interlayer insulating layer 13, and the drive circuit 45 applies signal voltages which are individually defined for the second transparent electrodes 14 and in which the low first potential (0 V) and the high second potential (6 V) are repeated as a whole, i.e., which have a spatially rectangular pattern, to the second transparent electrodes 14. Thus, a difference in refractive index arises between portions corresponding to the second transparent electrodes 14a, 14c, and 14e to which signal voltages at the first potential (0 V) are applied and portions corresponding to the second transparent electrodes 14b, 14d, and 14f to which signal voltages at the second potential (6 V) are applied. Then, a continuous refractive index difference occurs in the liquid crystal layer 40. Consequently, a dip of a blazed diffraction grating G is formed in portions corresponding to the second transparent electrodes 14a, 14c, and 14e to which signal voltages at the first potential (0 V) are applied, and a peak of the blazed diffraction grating G is formed in portions corresponding to the second transparent electrodes 14b, 14d, and 14f to which signal voltages at the second potential (6 V) are applied. Here, in a transmissive (blazed) diffraction grating, a phase difference is obtained by dividing the difference between the optical distance of passage of light in the dip of the diffraction grating and the optical distance of passage of light in the peak of the diffraction grating by the wavelength of light. Thus, in an optical deflector using liquid crystal, the phase difference is increased by increasing the difference in refractive index between portions to which signal voltages at a low potential are applied and portions to which signal voltages at a high potential are applied. In the first element substrate 20, the first transparent electrode 12 is provided at the sides of the second transparent electrodes 14 facing the first transparent substrate 10a, and the drive circuit 45 applies signal voltages at the first potential (0 V) to the first transparent electrode 12 and the third transparent electrode 22 of the second element substrate 30. Thus, portions of the liquid crystal layer 40 near the second transparent electrodes 14a, 14c, and 14e to which signal voltages at the first potential (0 V) are applied have a lower potential than that in a case where the first transparent electrode 12 is not provided, i.e., the potential at portions of the liquid crystal layer 40 near the second transparent electrodes 14a, 14c, and 14e approaches 0 V. In this manner, the difference between the refractive index of portions of the liquid crystal layer 40 near the second transparent electrodes 14a, 14c, and 14e to which signal voltages at the first potential (0 V) are applied and the refractive index of portions of the liquid crystal layer 40 near the second transparent electrodes 14b, 14d, and 14f to which signal voltages at the second potential (6 V) are applied becomes larger than that in a case where the first transparent electrode 12 is not provided. Thus, the phase difference can be increased as much as possible, thereby enhancing the diffraction efficiency.

In the optical deflector 50 of this embodiment, the first transparent electrode 12 is disposed at the sides of the second transparent electrodes 14 facing the first transparent substrate 10a. Thus, even when the electric field distribution shifts to lower potentials, the phase difference can be maintained or increased because the drive circuit 45 applies, to the second transparent electrodes 14b, 14d, and 14f to which signal voltages at the high second potential are applied, signal voltages higher than an applied voltage whose phase in the second transparent electrodes 14b, 14d, and 14f changes by 2π.

### Second Embodiment

FIG. 12 shows an application pattern of signal voltages in an optical deflector according to a second embodiment. FIG. 13 is a graph showing a phase profile in the optical deflector with an application pattern of signal voltages shown in FIG. 12. FIGS. 14 and 15 show application patterns of a first variation and a second variation, respectively, of signal voltages in the optical deflector of this embodiment. In the graph of FIG. 13, solid curve A represents an optical deflector 50 of this embodiment having a two-layer electrode configuration, and broken curve B represents the optical deflector 150 of the comparative example having the single-layer electrode configuration. In the following embodiments, portions already described with reference to FIGS. 1-11 are denoted by the same reference characters, and description thereof is not repeated.

In the first embodiment, the optical deflector 50 in which signal voltages with a spatially rectangular pattern are applied to the second transparent electrodes 14 is described as an example. In the second embodiment, an optical deflector 50 in which signal voltages with a spatially stepped pattern are applied to second transparent electrodes 14 is described as an example.

As illustrated in FIG. 12, using adjacent three of the second transparent electrodes 14 as one unit, a drive circuit 45 of this embodiment applies, to the second transparent electrodes 14, signal voltages in which a low first potential (0 V), an intermediate second potential (3 V), and a high third potential (6 V) are repeated. Specifically, a signal voltage of 0 V is applied to a first transparent electrode 12, the second transparent electrode 14a, the second transparent electrode 14d, and a third transparent electrode 22, a signal voltage of 3 V is applied to the second transparent electrode 14b and the second transparent electrode 14e, and a signal voltage of 6 V is applied to the second transparent electrode 14c and the second transparent electrode 14f.

In the optical deflector 50 of this embodiment, the potential at portions corresponding to the second transparent electrodes 14a and 14d to which the signal voltage of 0 V is applied is caused to approach 0 V by a first transparent electrode 12 to which the signal voltage of 0 V is applied. Thus, as illustrated in FIG. 13, the phase difference of the optical deflector 50 (see curve A in the graph) is larger than that of the optical deflector 150 of the comparative example having the single-layer electrode configuration (see curve B in the graph).

In the optical deflector 50 of this embodiment, using adjacent three of the second transparent electrodes 14 as one unit, signal voltages in which the first potential (0 V), the second potential (3 V), and the third potential (6 V) are repeated are applied. Alternatively, adjacent n (where n is a natural number greater than or equal to three) of the second transparent electrodes 14 may be used as one unit. Specifically, as illustrated in FIG. 14, the optical deflector 50 may be configured such that adjacent four of the second transparent electrodes 14 are used as one unit and signal voltages in which a first potential (0 V), a second potential (2 V), a third potential (4 V), and a fourth potential (6 V) are repeated are applied to the second transparent electrodes 14. The optical deflector 50 may also be configured such that adjacent five of the second transparent electrodes 14 are used as one unit and signal voltages in which a first potential (0 V), a second potential (1.5 V), a third potential (3 V), a fourth potential (4.5 V), and a fifth potential (6 V) are repeated are applied to the second transparent electrodes 14, as illustrated in FIG. 15.

As described above, in a first element substrate 20 of the optical deflector 50 of this embodiment, the second transparent electrodes 14 extend in parallel to one another on an interlayer insulating layer 13, and the drive circuit 45 applies signal voltages which are individually defined for the second transparent electrodes 14 and in which the low first potential (0 V), the intermediate second potential (3 V), and the high third potential (6 V) are repeated as a whole, i.e., which have a spatially stepped pattern, to the second transparent electrodes 14. In addition, in the first element substrate 20, the first transparent electrode 12 is disposed at the sides of the second transparent electrodes 14 facing a first transparent substrate 10a, and the drive circuit 45 applies a signal voltage at the first potential (0 V) to the first transparent electrode 12 and the third transparent electrode 22 of the second element substrate 30. Thus, in a manner similar to the first embodiment, the difference between the refractive index of portions of the liquid crystal layer 40 near the second transparent electrodes 14a and 14d to which a signal voltage at the low first potential (0 V) is applied and the refractive index of portions of the liquid crystal layer 40 near the second transparent electrodes 14c and 14f to which a signal voltage at the high third potential (6 V) is applied increases. Thus, the phase difference can be increased as much as possible, thereby enhancing the diffraction efficiency.

### Third Embodiment

FIG. 16 schematically illustrates a simplified configuration of an optical deflector 50 according to a third embodiment. FIG. 17 shows an application pattern of signal voltages in the optical deflector 50. FIG. 18 is a graph showing a phase profile in the optical deflector 50 with the application pattern of signal voltages shown in FIG. 17. FIGS. 19 and 20 show application patterns of a first variation and a second variation, respectively, of signal voltages in the optical deflector 50.

In the foregoing embodiments, the optical deflectors 50 in each of which signal voltages with the spatially rectangular or stepped pattern are applied to the second transparent electrodes 14. In the optical deflector 50 of the third embodiment, signal voltages with a spatially sinusoidal pattern are applied to second transparent electrodes 14.

As illustrated in FIG. 16, the optical deflector 50 of this embodiment includes a plurality of second transparent electrodes 14 including second transparent electrodes 14a-14i.

As illustrated in FIG. 17, using adjacent four of the second transparent electrodes 14 as one unit, a drive circuit 45 of this embodiment applies, to the second transparent electrodes 14, signal voltages in which a low first potential (0 V), an intermediate second potential (3 V), a high third potential (6 V), and an intermediate fourth potential (3 V) are repeated. Specifically, a signal voltage of 0 V is applied to a first transparent electrode 12, the second transparent electrode 14a, the second transparent electrode 14e, the second transparent electrode 14i, and a third transparent electrode 22, a signal voltage of 3 V is applied to the second transparent electrode 14b, the second transparent electrode 14d, the second transparent electrode 14f, and the second transparent electrode 14h, and a signal voltage of 6 V is applied to the second transparent electrode 14c and the second transparent electrode 14g.

In the optical deflector 50 of this embodiment, the potential at portions of the second transparent electrodes 14a, 14e, and 14i to which the signal voltage of 0 V is applied is caused to approach 0 V by the first transparent electrode 12 to which the signal voltage of 0 V is applied. Thus, as illustrated in FIG. 18, the phase difference of the optical deflector 50 of this embodiment (see curve A in the graph) is larger than that of the optical deflector 150 of the comparative example having the single-layer electrode configuration (see curve B in the graph).

In the optical deflector 50 of this embodiment, using adjacent four of the second transparent electrodes 14 as one unit, signal voltages in which the first potential (0 V), the second potential (3 V), the third potential (6 V), and the fourth potential (3 V) are repeated are applied, as an example. Alternatively, adjacent 2n+2 (where n is a natural number) of the second transparent electrodes 14 may be used as one unit. Specifically, as illustrated in FIG. 19, the optical deflector 50 may be configured such that adjacent six of the second transparent electrodes 14 are used as one unit and signal voltages in which a first potential (0 V), a second potential (2 V), a third potential (4 V), a fourth potential (6 V), a fifth potential (4 V), and a sixth potential (2 V) are repeated are applied to the second transparent electrodes 14. The optical deflector 50 may also be configured such that adjacent eight of the second transparent electrodes 14 are used as one unit and signal voltages in which a first potential (0 V), a second potential (1.5 V), a third potential (3 V), a fourth potential (4.5 V), a fifth potential (6 V), a sixth potential (4.5 V), a seventh potential (3 V), and an eighth potential (1.5 V) are repeated are applied to the second transparent electrodes 14, as illustrated in FIG. 20.

As described above, in the first element substrate 20 of the optical deflector 50 of this embodiment, the second transparent electrodes 14 extend in parallel to one another on the interlayer insulating layer 13, and the drive circuit 45 applies, to the second transparent electrodes 14, signal voltages which are individually defined for the second transparent electrodes 14 and in which the low first potential (0 V), the intermediate second potential (3 V), the high third potential (6 V), and the intermediate fourth potential (3 V) are repeated as a whole, i.e., which have a spatially sinusoidal along the direction in which the electrodes are arranged. In addition, in the first element substrate 20, the first transparent electrode 12 is disposed at the sides of the second transparent electrodes 14 facing the first transparent substrate 10a, and the drive circuit 45 applies a signal voltage at the low first potential (0 V) to the first transparent electrode 12 and the third transparent electrode 22 of the second element substrate 30. Thus, in a manner similar to the first embodiment, the difference between the refractive index of portions of the liquid crystal layer 40 near the second transparent electrodes 14a, 14e, and 14i to which a signal voltage at the low first potential (0 V) is applied and the refractive index of portions of the liquid crystal layer 40 near the second transparent electrodes 14c and 14g to which a signal voltage at the high third potential (6 V) is applied increases. Thus, the phase difference can be increased as much as possible, thereby enhancing the diffraction efficiency.

In each of the foregoing embodiments, the optical deflector including the liquid crystal layer of a homogeneous alignment type using a nematic liquid crystal material having a positive dielectric constant anisotropy is described as an example. However, the present invention is applicable to, for example, an optical deflector including a liquid crystal layer using a ferroelectric liquid crystal material and an optical deflector including a liquid crystal layer of a homeotropic alignment type using a nematic liquid crystal material whose dielectric constant anisotropy is negative.

### INDUSTRIAL APPLICABILITY

As described above, according to the present invention, a phase difference can be increased in an optical deflector using liquid crystal. Thus, the present invention is useful for beam steering to both eyes in a 3D-display which is capable of tracking the position of an observer, tracking devices in the overall displays, optical scanners, optical switches for optical communication, etc.

### DESCRIPTION OF REFERENCE CHARACTERS

10a first transparent substrate
10b second transparent substrate
12 first transparent electrode
13 second interlayer insulating layer
14 second transparent electrode
20 first element substrate
22 third transparent electrode
30 second element substrate
40 liquid crystal layer
45 drive circuit
50 optical deflector

1. An optical deflector comprising:
a first element substrate including a first transparent substrate, a first transparent electrode located at the first transparent substrate, an interlayer insulating layer covering the first transparent electrode, and a plurality of second transparent electrodes extending in parallel with one another on the interlayer insulating layer;
a second element substrate including a second transparent substrate and a third transparent electrode located at the second transparent substrate, the third transparent electrode facing the second transparent electrodes on the first element substrate;
a liquid crystal layer disposed between the first element substrate and the second element substrate; and
a drive circuit configured to apply signal voltages which are individually defined for the second transparent electrodes and in which a low potential and a high potential are repeated as a whole, to the second transparent electrodes, and to apply a signal voltage at the low potential to the first transparent electrode.

2. The optical deflector of claim 1, wherein the drive circuit applies, to the second transparent electrodes to which a signal voltage at the high potential is applied, a signal voltage higher than an applied voltage whose phase in the second transparent electrodes changes by 2π.

3. The optical deflector of claim 1, wherein the drive circuit applies, to the second transparent electrodes, signal voltages in which a first potential and a second potential higher than the first potential are repeated, using adjacent 2n (where n is a natural number) of the second transparent electrodes as one unit.

4. The optical deflector of claim 1, wherein the drive circuit applies, to the second transparent electrodes, signal voltages in which a first potential, a second potential, . . . , and an n-th potential that increase in this order are repeated, using adjacent n (where n is a natural number greater than or equal to three) of the second transparent electrodes as one unit.

5. The optical deflector of claim 1, wherein the drive circuit applies, to the second transparent electrodes, signal voltages in which a first potential, a second potential, . . . , an (n+1)th potential, and an (n+2)th potential that increase in this order and an (n+3)th potential equal to the (n+1)th potential, . . . and a (2n+2)th potential equal to the second potential that decrease in this order are repeated, using adjacent 2n+2 (where n is a natural number) of the second transparent electrodes as one unit.

6. The optical deflector of claim 1, wherein the drive circuit makes a potential of a signal voltage to be applied to the third transparent electrode equal to a potential of a signal voltage at the low potential to be applied at least one of the second transparent electrodes.

7. The optical deflector of claim 3, wherein the drive circuit makes a potential of a signal voltage to be applied to the third transparent electrode equal to a potential of a signal voltage at the first potential to be applied to at least one of the second transparent electrodes.
